(19) United States
(12) Patent Application Publication
(10) Pub. No.: US 2017/0300178 A1
(43) Pub. Date: Oct. 19, 2017

(54) System and Methods for Syncing Web Application Records Across Multiple Browser Windows

(71) Applicant: Lexmark International Technology, Sarl, Meyrin (CH)

(72) Inventor: Shane Evan Blazek, Shawnee, KS (US)

(21) Appl. No.: 15/133,006

(22) Filed: Apr. 19, 2016

(51) Int. Cl. G06F 3/0481; H04L 29/08; G06F 17/22

(52) U.S. Cl. CPC G06F 3/0481; G06F 17/2247; H04L 67/02

(57) ABSTRACT

A method for automatically syncing data between a first and a second application is disclosed. The method may include identifying if the first application is accessed using a browser, determining an element in the first application having data for use in syncing the first and the second application, and retrieving the data from the element in the first application. The method further includes transmitting the retrieved data to the second application and syncing the first and second applications by retrieving by the second application one or more records based on the data retrieved from the element in the first application and displaying in the second application, the one or more records associated with the data retrieved from the element in the first application.

### CROSS REFERENCES TO RELATED APPLICATIONS

This patent application is related to the U.S. patent application Ser. No. ______, entitled “System and Methods for Retrieving Related Content from a First Application and Displaying Related Content on a Browser Accessing a Web Application”, filed contemporaneously herewith and assigned to the assignee of the present application.

### STATEMENT REGARDING FEDERALLY SPONSORED RESEARCH OR DEVELOPMENT

None.

### REFERENCE TO SEQUENTIAL LISTING, ETC.

None.

### BACKGROUND

### 1. Technical Field

The present disclosure relates generally to a system and methods for syncing records, more particularly, syncing data records between two web applications that are being accessed using at least two browser windows.

### 2. Description of the Related Art

Businesses, educational institutions, and various industries often rely on computing devices and software applications to perform and/or manage their day-to-day operations. In fact, a particular business, educational institution, or industry may rely on multiple software applications to perform and/or manage their day-to-day operations.

In business processes that involve at least two software applications such as, for example, two web applications, a user typically opens one browser window to access a first application, and another browser window to access a second application. In an example scenario, a human resource representative may access a web browser and open the first browser window to access a website for managing employee information such as, for example, a Human Resource (HR) website. In another window, the user may access another web application such as, for example, an electronic content management (ECM) web site having documents related to the employees accessed using the HR website.

Typically, to access the documents related to the employees in the HR website, the user manually navigates the ECM website to search for the documents in order to retrieve and access them using the ECM website. This manual method of retrieving and syncing of the two web applications having common variables (e.g., employees) may be time-consuming and inefficient.

Accordingly, there exists a need for a method of automatically syncing data records across multiple browser windows having one or more common variables. There exists a need for an advanced retrieval of related content on a second web application based on data accessed on a first web application.

### SUMMARY

A system capable of and methods of automatically syncing data between a first and a second application. The method includes identifying if the first application is accessed using a browser and determining an element in the first application having data for use in syncing the first and the second applications. The data may then be retrieved from the element in the first application and upon identifying if the second application is accessed using the browser, retrieving by the second application one or more records associated with the data retrieved from the element in the first application. The method further includes displaying in the second application, the one or more records associated with the data retrieved from the element in the first application.

In one aspect of the example embodiment, a change in the data in the element of the first application may be determined and upon determining the change in the data, the second application may retrieve one or more records associated with the change of the data retrieved from the element in the first application. In another aspect of the example embodiment, the determining of the change in the data in the element of the first application may include continuously monitoring a subsequent instance of the data in the element of the first application and comparing the subsequent instance with the previously retrieved data from the element.

In another aspect of the example embodiment, the determining the element in the first application having data to be monitored may be performed by an application such as, for example, a browser extension. In yet another aspect, a user may select another element in at least one of the first and the second applications whose data is to be monitored by the application installed in the browser.

From the foregoing disclosure and the following detailed description of various example embodiments, it will be apparent to those skilled in the art that the present disclosure provides a significant advance in the art of syncing data between at least two applications accessed in multiple browser windows of a browser application. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows an example system for use in syncing data records between at least two applications accessed using multiple browser windows.

FIG. 2 shows an example browser having two applications executing in multiple windows of the browser.

FIG. 3 shows an example source reference of an application that includes a specified element and example HTML elements that define how the HTML web page of an application is rendered and displayed in browser.

FIG. 4 is an example method of syncing web application records across multiple windows of a browser.

FIG. 5 shows an example advanced retrieval of data records in example application, Documents based on the application data of the element being monitored in example application, Accounts.

FIG. 6 shows an example method of continuously syncing data records in applications accessed in multiple browser windows.

FIG. 7 shows an example Accounts application accessed in a window of browser, and a second example application Documents simultaneously opened in a second browser window.

FIG. 8 shows example retrieved data records in Documents including data records related to the second instance of the collected application data, “Jane Smith.”

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are a system and methods of automatically syncing data between a first and a second application. One example embodiment of the method includes identifying if the first application is accessed using a browser and determining an element in the first application having data for use in syncing the first and the second applications. The data may then be retrieved from the element in the first application and upon identifying if the second application is accessed using the browser, retrieving by the second application one or more records associated with the data retrieved from the element in the first application. The method further includes displaying in the second application, the one or more records associated with the data retrieved from the element in the first application.

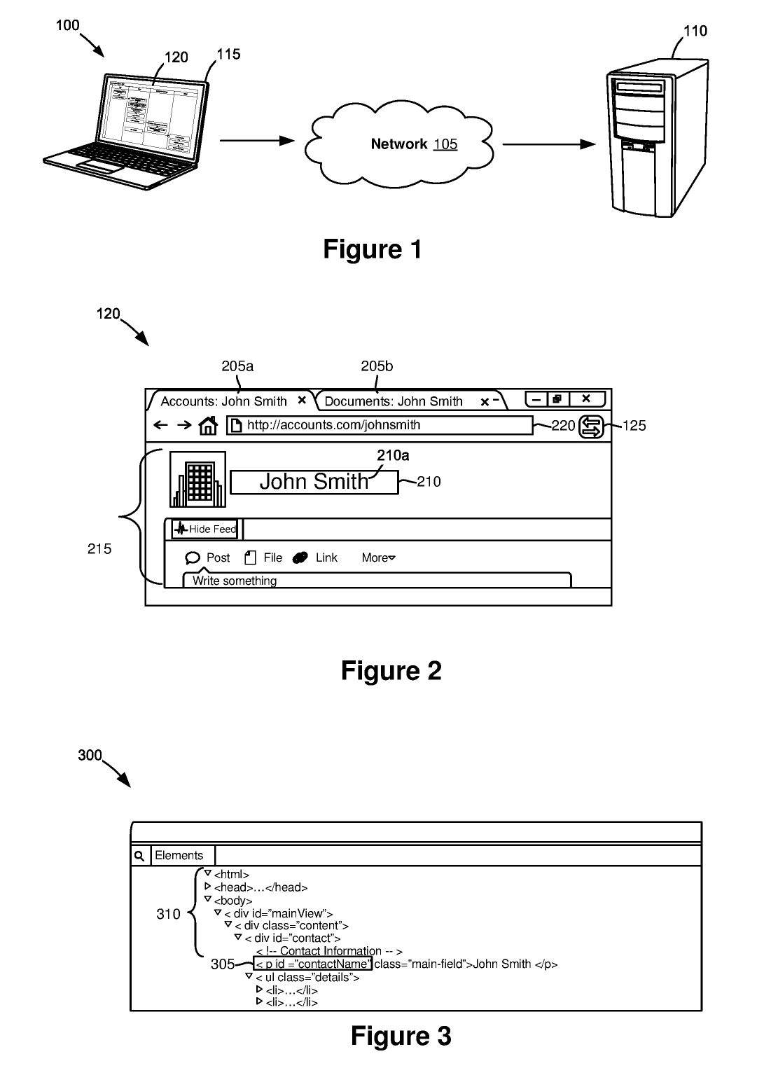

FIG. 1 shows an example system 100 for use in syncing data records between at least two applications accessed using multiple browser windows. The syncing of the data records between the two applications may be performed using one or more variable data that is common between the two applications. System 100 includes a network 105 and a server computer 110 communicatively connected to a client device 115 through network 105. Network 105 is any network, communications network, or network/communications network system such as, but not limited to, a peer-to-peer network, a hybrid peer-to-peer network, a Local Area Network (LAN), a Wide Area Network (WAN), a public network, such as the Internet, a private network, a cellular network, a combination of different network types, or other wireless, wired, and/or a wireless and wired combination network capable of allowing communication between two or more computing systems, as discussed herein, and/or available or known at the time of filing, and/or as developed after the time of filing.

Server computer 110 may be a computing device that hosts content for accessing by client device 115 through network 105. Examples of server computer may include but are not limited to a personal computer, a server computer, a series of server computers, a mini computer, and a mainframe computer. Server computer 110 may also be a web server (or a series of web servers) that hosts data records that may be accessed by a user through one or more web applications opened using browser 120. In another example embodiment, server computer 110 may be a server that hosts an application for syncing data records across a plurality of web applications accessed using browser 120.

Client device 115 may be a personal computer, as shown in FIG. 1 that may be used by a user to access content and one or more records using browser 120. In alternative example embodiments, client device 115 may be any computing device capable of executing applications therein such as, for example, mobile phones, laptops and tablet computers. Client device 115 may include a processor (not shown) and a computer-readable medium (not shown), such as a random access memory (RAM), coupled to the processor. The processor may execute computer-executable program instructions stored in the memory. Computer-executable program instructions may include a set of instructions for executing browser 120 such as, for example, a web browser for use in opening web applications.

Browser 120 may be an application installed in client device 115 that is used to retrieve, render and present resources such as, a web page, image, video, or other piece of content on the World Wide Web (WWW). Browser 120 may be used to execute one or more software applications that are used for accessing data records. In one example embodiment, browser 120 may be a web browser or any other similar program that accesses information from the WWW, or from a remote computer, such as server computer 110.

In an alternative example embodiment, browser 120 may be software or another computer program, which is executable by a processor and can be stored on computer-readable media. In some example embodiments, an application may refer to firmware and/or a combination of software and firmware. In some other example embodiments, an application may be executed on the web or over a network. An application processes, organizes, manipulates, stores, generates, displays, and/or otherwise renders application data that can be used by the user through browser 120. Application data is the information processed, organized, manipulated, stored, displayed, and/or otherwise rendered by an application. In the present disclosure, application data may also be referred to as the value contained in an element.

Browser 120 may be used to display one or more web applications. Web applications may be any software that runs in a web browser such as, for example, browser 120. Examples of web applications may be a web page or any web content capable of being rendered in browser 120. Web applications may be created in a browser-supported programming language such as, for example, hypertext markup language (HTML), Javascript, CSS, and the like. Browser 120 may display a plurality of web applications at a time through browser tabs or windows, as will be known in the art.

FIG. 2 shows an example browser 120 having two applications executing in multiple windows of browser 120. Browser 120 may be installed with an extension 125. Extension 125 may be software or another computer program, other than browser 120 or the operating system hosting browser 120 within client device 115 that is executable by a processor and can be stored on computer-readable media. In some example embodiments, extension 125 may be executed on the web or over a network, such as a web application.

Extension 125 may monitor web applications executed using browser 120 for data or values collected from one or more specified elements and uses the collected data to identify records and/or documents relevant to the element value or application data. Extension 125 may be an application, plugin, or additional code performed by browser 120 that interacts with the windows or tabs of browser 120 to retrieve one or more values from elements in web applications displayed in browser 120. Extension 125 may extend the functionality of browser 120 to include syncing records between at least two applications executed in browser 120 based on the values retrieved from the one or more elements. In one alternative example embodiment, the actions performed by extension 125 may be performed by browser 120. The actions may be performed within the code space of browser 120 or, alternatively, outside the code space of browser 120.

In an example embodiment, extension 125 may be configured to monitor a specific element in a first application executed using browser 120. Extension 125 may determine which applications, URLS, fields, or other elements in the application that are to be monitored and what applications and/or URLs to provide the values to. These settings may be configured by a user such as an administrator for one or more users of a client device 115 having browser 120 installed with extension 125. The settings may be stored in a location extension 125 can retrieve upon execution such as, for example, a text file, a memory, a remote server or a database communicatively connected with extension 125.

Extension 125 may then retrieve values from the element for use in identifying and retrieving relevant records in a second application executed using browser 120. The value of the element may be sent to the second application for example, directly from the first application to the second application, or via one or more URL parameters. The relevant records may be retrieved and displayed in the second application such that an advanced retrieval of relevant records is performed automatically on the second application using data currently being accessed in the first application. The advanced retrieval of relevant records may enable the two applications executed in browser 120 to display synchronized data records automatically.

In one example embodiment, neither the first nor the second application may be aware of the execution of the other application during the syncing and advanced retrieval processes, as will be discussed herein. The first and the second applications may also be unaware of extension 125 in order to execute the syncing and advanced retrieval process. Extension 125 may be configured specifically for each of the applications, but may not have to be coded specifically for the applications. Extension 125 may be able to work with almost any application without a specific code in any of the applications. The execution of the actions for extension 125 to sync the two applications may not rely on the existence of code-level integration or the production of additional source code on a per application basis to gather data to be synced that is generated from another application. A “per application basis” means that source code is not produced separately for each application that generates data to be synced. In particular, extension 125 does not modify any of the application's source code in order to sync the application with another, and extension 125 does not require its own source code to be modified on a per application basis in order to perform a sync using that application.

In some other example embodiments, an application may refer to firmware and/or a combination of software and firmware. An application may be configured to process, organize, manipulate, store, generate, display, and/or otherwise render values or application data that can be used by extension 125 for advanced retrieval and syncing of application data and records across applications simultaneously executed using browser 120.

FIG. 2 also shows a first example application Accounts 205a opened in a first window in browser 120, and a second example application Documents 205b simultaneously opened in a second window. FIG. 2 shows an example display rendered by Accounts 205a having example application data in a specified element 210, and other elements 215 of the application. Application data may be data that is rendered by Accounts 205a and found in an element monitored by extension 125 such as, for example, element 210.

In one example embodiment, each of elements 215, including element 210, may be a Hypertext Markup Language (HTML) tag or HTML user interface (UI) element, container, or variable that contains information, data or value that may be used to locate a record by another application. The HTML elements may be components of an HTML document and the information, data or value may include such other HTML elements, text, and the like. In this disclosure, the specified value contained in an HTML element may also be referred to herein to application data.

Application data contained in an element can be characterized as any data type capable of being recognized by an application, such as, for example, a label, a string identifier, a number identifier, any string of text. For example, application data in Accounts 205b may be an account name, date, employee identification number, customer number, and the like.

In another example embodiment, specified element 210 may be logical location of data or information in a source reference of the application that may be defined by a user and characterized by the user as being a particular type of data. A source reference, as used herein, refers to a set of instructions, code, and/or application data such as those that are rendered for the display of the application 205. The application data corresponding to the example specified element 210 may be “John Smith” 210a.

FIG. 3 shows an example source reference 300 of an application that includes a specified element 305 and example HTML elements 310 that define how the HTML web page of an application is rendered and displayed in browser 120. In this example source reference 300, the example HTML elements 310 are for Accounts 205a. For illustrative purposes, element <p id=“contactName”> 305 is the HTML element to be monitored and whose value will be retrieved by extension 125. Element 310 may be defined by a user using extension 125, or an application communicatively connected to extension 125. Element 310 and other elements in Accounts 205a that are configured to be monitored by extension 125 may be stored in a computer storage media and organized in a database, and the like.

In another example embodiment, elements 215 may be a rendered source reference. For example, element 215 may be defined as a tree node, an object, coordinates of a display or other user interface screen, a window control or relative to a window control, or using another data location method.

In yet another example embodiment, element 215 may be an area of a display containing application data that has been defined and characterized by a user of the extension 125. In this aspect, element 215 may be identified by its spatial location within a display rendered by an application executed using browser 120, such as through one or more coordinates. A display, as used herein, refers to a presentation of an image, document, user interface, and/or other application data to a display device. For example, user interface screens for application 205a, including user interface screens that visually present application data, may be displays. One or more displays generated by the application may have one or more defined elements 215.

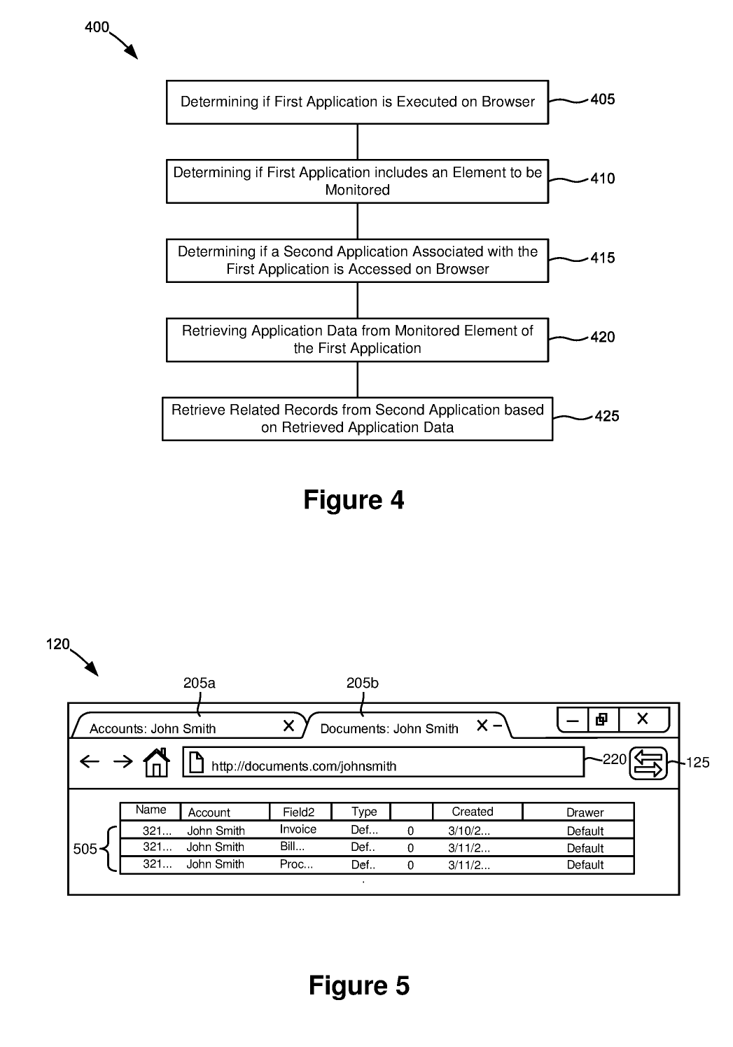

FIG. 4 is an example method 400 of syncing web application records across multiple windows of a browser. For illustrative purposes, the syncing of the application records is performed between Accounts application 205a and Documents application 205b executed in multiple windows or tabs of browser 120a.

At block 405, it is determined if a first application is executed on browser 120. The determining may be performed by extension 125 and the first application may be an application that extension 125 has been configured to monitor such as, for example, Accounts 205a. A user may be given access to settings that allow the user to specify a software application to be synced with another application executed in browser 120. Alternatively, a system administrator may have, at a previous time, specified settings for one or more users before the user has loaded browser 120 and extension 125. The settings may be stored on a user's system such as, for example, a file, a database, or a local storage system. The settings may also be retrieved from a remote system such as, for example, a remote server, a database or a service, as will be known in the art.

For example, extension 125 may receive input from a user indicating an identifier of an application such as, for example, an application label “Accounts,” which extension 125 may use to identify a first application to be synced with another application. An identifier for the application may include a Uniform Resource Locator (URL) of the first application, a descriptive text associated with the application such as, for example, a title located in the title bar of browser 120, and other identifiers as will be known in the art.

At block 410, once extension 125 determines that browser 120 is used to access a first application, it is determined if the first application includes at least one element to be monitored. Determining if the first application includes at least one element to be monitored may be performed by checking an identifier of the first application and checking if the first application identifier is associated with at least one element that has been configured to be monitored at a time prior to the accessing of the first application. For example, an identifier for Accounts 205a may be “Accounts: John Smith,” and determining if Accounts 205a includes at least one element to be monitored may be performed by retrieving at least a part of the title of Accounts 205a, such as “Accounts”, and determining if the “Accounts” application has at least one element to be monitored, such as for example, the element containing application data in element 210 (e.g. “John Smith”). A list of applications having an element to be monitored and thereby configurable to be synced with at least one other application may be stored in a database communicatively connected to extension 125.

Alternatively, extension 125 may include settings that allow a user to select one or more elements in a first application having a value to be monitored, the application data to be used to sync the first application with another application. For example, a user may specify before or during the accessing of Accounts 205a in browser 120, one or more elements that may contain application data that can be used to retrieve related records in a second application such as, for example, Documents 205b. For example, the user may specify, before or during the accessing of Accounts 205a, using extension 125 or an application communicatively connected to extension 125, to monitor element 215 for application data that can be used to sync with Documents 205b.

At block 415, it is determined if a second application associated with the first application is being accessed on browser 120 while the first application is executed on browser 120. Extension 125 may listen for applications being opened using browser 120 while the first application is being executed in browser 120 and may then determine if any of the applications opened using browser 120 is associated with the first application. For example, when browser 120 is used to open another application such as, for example Documents 205b, extension 125 may determine if the opened application is related to a currently opened application, Accounts 205a, such that one of the elements in at least one Accounts 205a and Documents 205b, may be monitored for application data that will be used to sync the two applications.

At block 420, if a second application related to a currently opened first application is executing on browser 120, extension 125 retrieves the application data from a monitored element of the first application. In an alternative embodiment, the application data may be retrieved from a monitored element in the second application.

For example, a user accesses Documents 205b while Accounts 205a is opened in another tab of browser 120. Once it is determined that Documents 205b is configured to be synced with Accounts 205a using application data from element 215 in Accounts 205a, extension 125a retrieves the application data “John Smith” 210a.

Retrieving the application data from the monitored element includes collecting data from the element of the source reference or the display generated by the one of the applications. For example, the source reference for an HTML page is the HTML code and the application data for the HTML page is collected before, during, and/or after the HTML page is rendered as a display. In this example, extension 125 may collect application data from the HTML source reference before, during, and/or after rendering the HTML display. In another example, the monitored element may be a raster image or a bitmap image. In this example, extension 125 collects the application data from the source reference image before, during, or after the image is rendered as a display.

At block 425, the retrieved application data is then used to retrieve related records from the other application. The retrieving of the related records may be performed by using the value retrieved from the element in the first application as a parameter to the URL that will be used to execute code that delivers the data to the second application. For example, a JavaScript call in the other window that is used to execute the second application may be executed such that the value from the element is used as a parameter that will retrieve the related records for the second application.

For example, “John Smith” may be used by extension 125 to sync Accounts 205a and Documents 205b by using the collected application data “John Smith” 210a to query for one or more data records related to the “John Smith” account being accessed using Accounts 205a. The related data records are then displayed in Documents 205b, thereby syncing the records being accessed in both Accounts 205a and Documents 205b.

FIG. 5 shows an example advanced retrieval of data records in example application, Documents 205b based on the application data of the element being monitored in example application, Accounts 205a. As shown in Documents 205b, example documents 505 relating to John Smith are retrieved and displayed such that the data displayed in both Accounts 205a and Documents 205b are automatically synchronized using method 400, and without the need for a user to manually execute the retrieval operation in Documents 205b in order to sync the two applications.

In one example embodiment, extension 125 may query a database communicatively connected to Documents 205b to identify one or more records, such as example documents 505, having properties that match the properties of the application data collected from element 215. Alternatively, value of the element may be sent to the second application by extension 125 directly or via one or more URL parameters, and Documents 205b performs the searching using the sent parameters.

After identifying one or more documents that fit the query criteria, extension 125 may proactively display the matching documents or thumbnails of the documents. In some example embodiments, extension 125 may display a list of matching documents on a user interface for review by the user. In one aspect, a pre-determined maximum threshold for the number of matching document properties may limit the number of documents displayed by extension 125. The matching documents may be displayed in Accounts 205b.

Alternatively, after extension 125 provides the value of the element to Documents 205b, and the value may be used as a parameter in Documents 205b where it is transformed to a format that is relevant to Documents 205b. Documents 205b may then find the related information or data records of the value, and perform one or more actions on the related data records such as, displaying, previewing, and the like. For example, extension 125 may retrieve the value “John Smith” from the monitored element. The value may be converted to a search string such as, “&query=johnsmith&fullresults=true&folder=JohnsEmployee” that will be passed to the Documents 205b for use in searching related records based on the “John Smith” value. Alternatively, the values may also be transformed such as, for example, turning a first element value, and a second element value to a single string that is passed to the second application. In another alternative example embodiment, a substitution string may be used such as, for example, retrieving one or more values from one or more elements of the first application and substituting the one or more values into variable portions of a string. For example, if values “John,” “Smith,” and “Corporation” are retrieved from one or more elements of the first application, the values may substitute an example string: “&query={Name LastName}&employeer={Employeer}” thereby creating a “&query=JohnSmith&employeer=Corporation”.

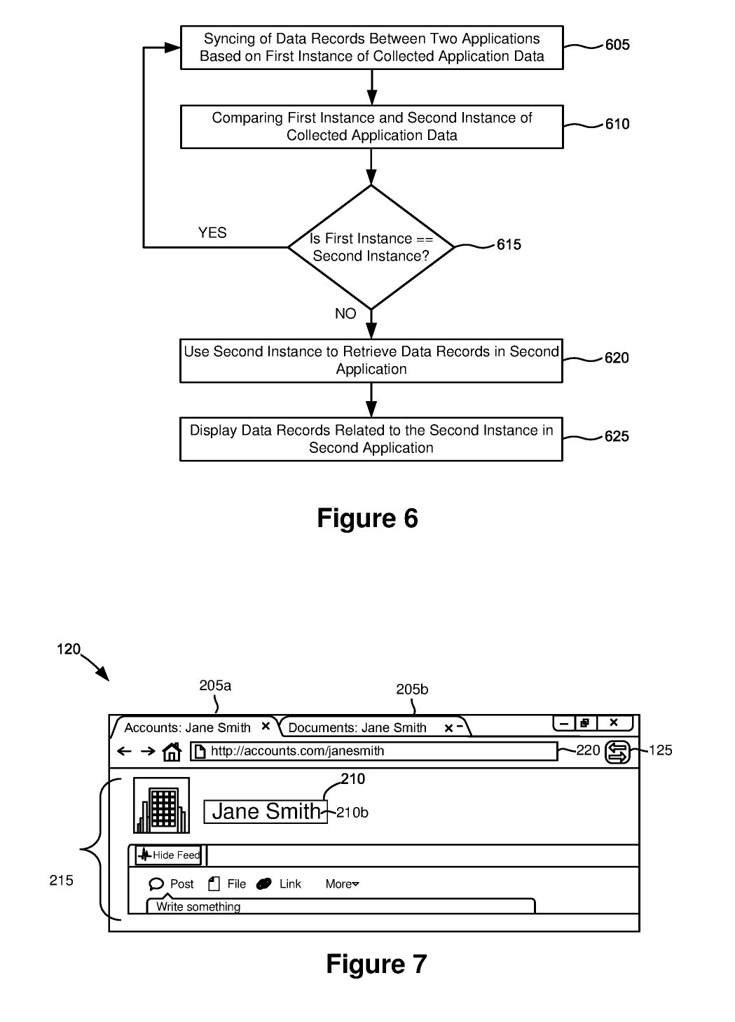

Extension 125 may also monitor any changes in the application data in element 215 and automatically retrieve new data records relating to the new application data in monitored element 215 such that Accounts 205a and Documents 205b are continuously synchronized all throughout their execution on browser 120. For example, FIG. 6 shows an example Accounts 205a wherein a user accesses a new Jane Smith account.

FIG. 6 shows an example method 600 of continuously syncing data records in applications accessed in multiple browser windows when a change of the value in an element is detected. Method 600 may be performed after the initial syncing of the data records in the first and second applications as illustrated in method 400 of FIG. 4. Changes in the value of an element may occur using one or more events performed in the applications displayed in browser 120 such as, for example, when a user types a new value in a field, or clicks a link that causes a value in the field to change. Extension 125 may also monitor if URL 220 in browser 120 changes and re-queries the field when a change is detected.

At block 605, data records between two applications accessed on multiple browser windows are synced based on a first instance of collected application data. The syncing is performed by displaying data records in the second application, the data records corresponding to application data collected from a monitored element in the first application. For example, FIG. 5 shows an example browser window showing Documents 205b displaying records related to Accounts 205a that is used to access a “John Smith” account. The displaying of the related records may be performed when extension 125 automatically and continuously collects application data from the monitored element and retrieves the related records for displaying in Documents 205b. The collected application data such as, for example, “John Smith” may be a first instance of the application data that is used to identify and retrieve the related records in Documents 205b. Extension 125 may continuously collect application data from the monitored element to generate a second instance of the application data.

At block 610, extension 125 may compare the first instance of the collected application data and the second instance of the application data to determine if a discrepancy exists between the first instance and the second instance of the collected application data. If a discrepancy is not identified at block 615, extension 125 may do nothing and the second application may continue displaying the related records of the first instance of the application data. If a discrepancy is identified at block 615, extension 125 may automatically use the second instance of the application data to retrieve data records using the second application and at block 625, the related records retrieved based on the second instance of the collected application data is displayed at the second application.

For example, extension 125 may continuously collect application data from element 210 in Accounts 205a to detect any changes made in the application data. The first instance of the collected application data may be “John Smith,” and extension 125 subsequently retrieves the value and displays the related records of “John Smith” in Documents 205b, as shown in FIG. 5. Alternatively, extension 125 may also send the value to Documents 205b and allows Documents 205b to use the value for one or more functions such as, retrieving and displaying the related records of “John Smith”.

During the continuous collection of application data from element 210b, extension 125 may collect a second instance of the application data such as, for example, “Jane Smith” 210b. Extension 125 may compare the first instance and the second instance to check for discrepancy, and when extension 125 determines that the first instance is different from the second instance of the collected application data, extension 125 notifies Documents 205b to reflect the change made in Accounts 205a, thereby continuously and automatically syncing the two applications accessed in multiple browser windows.

FIG. 7 shows an example Accounts 205a application accessed in a window of browser 120, and a second example application Documents 205b simultaneously opened in a second browser window. The example display of Accounts 205a may be rendered after the user has accessed a previous account, “John Smith” as illustrated in example Accounts 205 in FIG. 2. In the illustrative embodiment of FIG. 7, Accounts 205 is accessing an account under “Jane Smith” after accessing the first account “John Smith”, thereby changing the application data displayed or rendered in element 215 from “John Smith” 210a to “Jane Smith” 210b. Extension 125 may be configured to monitor any changes in element 215, and continuously compare a first instance of the collected application data with a second instance of a subsequently collected application data. In this example embodiment, the records opened in the second application Documents 205b may still be related to the first instance of the collected application data, “John Smith.” Extension 125 compares the first and the second instances of the collected application data and when a discrepancy is identified, extension 125 may automatically update the data records in Documents 205b to display data records related to the second instance. Alternatively, extension 125 may also send the second instance of the value to Documents 205b and allows Documents 205b to use the value for one or more functions such as, retrieving and displaying the related records of “John Smith”.

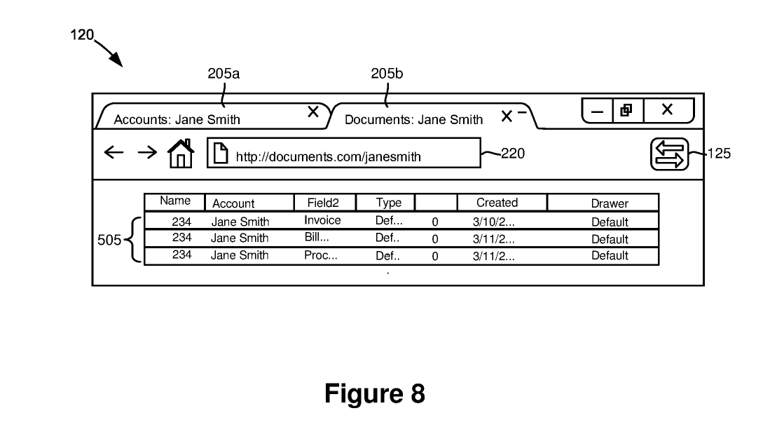

FIG. 8 shows an example advanced retrieval data records in Documents 205b including data records related to the second instance of the collected application data, “Jane Smith” 210b. As shown in Documents 205b, example documents 505 relating to “Jane Smith” are retrieved and displayed thereby automatically syncing data displayed in both Accounts 205a and Documents 205b using method 600. Method 600 performs the continuous monitoring and syncing of data between the two applications accessed in multiple browser windows without a user manually executing the retrieval operation in Documents 205b.

It will be understood that the example applications described herein are illustrative and should not be considered limiting. It will be appreciated that the actions described and shown in the example flowcharts may be carried out or performed in any suitable order. It will also be appreciated that not all of the actions described in FIGS. 3-5 need to be performed in accordance with the example embodiments of the disclosure and/or additional actions may be performed in accordance with other embodiments of the disclosure.

Many modifications and other example embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for automatically syncing data between a first and a second application accessed using a browser, comprising:
determining by an extension installed in the browser, an element in the first application having data for use in syncing the first and the second applications;
upon positive determination, retrieving by the extension the data from the element in the first application;
transmitting by the extension the data to the second application;
retrieving by the second application one or more records based on the data retrieved from the element in the first application; and
displaying in the second application, the one or more records associated with the data retrieved from the element in the first application.

2. The method of claim 1, further comprising displaying in the second application the one or more records associated with the data retrieved from the element in the first application.

3. The method of claim 1, wherein the transmitting the data to the second application includes passing the data using a custom uniform resource locator (URL).

4. The method of claim 1, wherein the transmitting the data to the second application includes passing the data through executing a code in the second application.

5. The method of claim 1, further comprising transforming the data to a format prior to the transmitting the data to the second application.

6. The method of claim 1, further comprising receiving from a user another element in at least one of the first and second applications whose data to be monitored by the extension installed in the browser.

7. A method for automatically syncing data between a first and a second web application opened using a web browser, comprising:
accessing the first and the second web applications using the web browser;
using an extension installed in the web browser, identifying an element in the first web application having a value to be used to sync data between the first and the second web applications;
retrieving the value of the element in the first web application;
transmitting the value of the element to the second application using the extension;
retrieving, using the second web application, one or more documents based on the received value of the element in the first web application; and
displaying using the second web application the one or more documents associated with the value.

8. The method of claim 7, further comprising monitoring using the extension if the value in the selected element of the first web application changes.

9. The method of claim 8, further comprising upon positive determination, transmitting the change of the value to the second web application.

10. The method of claim 9, further comprising retrieving and displaying in the second web application the one or more documents associated with the change in the value of the selected element of the first web application.

11. The method of claim 7, further comprising determining if the second web application accessed using the web browser is configured to be synced with the first web application.

12. The method of claim 11, further comprising, upon positive determination, performing the identifying the element, the retrieving the value of the element, and the transmitting the value to the second application.

13. The method of claim 7, wherein identifying the element in the first web application includes identifying a hypertext markup language (HTML) element in the first web application having a value configured to be retrieved and be used to sync data between the first and the second web applications.

14. A computing device having non-transitory computer readable storage medium containing one or more instructions for automatically syncing data between a first and a second application accessed using a browser, the one or more instructions comprising:
opening the first and the second applications using the browser;
selecting an element in the first application whose value is to be monitored by an extension installed in the browser;
retrieving, by the extension, the value in the selected element;
transmitting the value to the second application;
retrieving using the second application one or more records associated with the value; and
displaying in the second application the one or more documents associated with the value retrieved from the element in the first application.

15. The computing device of claim 14, wherein the one or more instructions for opening the first application includes opening the first application on a first window of the browser.

16. The computing device of claim 14, wherein the one or more instructions for opening the second application includes opening the second application on a second window of the browser.

17. The computing device of claim 14, wherein the one or more instructions for selecting the element in the first application includes saving the selected element in a remote server for retrieval at a later time.

18. The computing device of claim 14, further comprising one or more instructions for retrieving the saved selected element from the remote server upon identifying that the first application is opened using the browser.

19. The computing device of claim 14, further comprising one or more instructions for monitoring by the extension if the value in the selected element changes.

20. The computing device of claim 19, further comprising one or more instructions for updating the one or more documents to be displayed in the second application by transmitting the change in the value to the second application and retrieving using the second application one or more records associated with the change in the value of the selected element in the first application.
